(19) United States
(12) Patent Application Publication
(10) Pub. No.: US 2023/0058363 A1
(43) Pub. Date: Feb. 23, 2023

(54) SEMANTIC SIMILARITY FOR SKU VERIFICATION

(71) Applicant: Rehrig Pacific Company, Los Angeles, CA (US)

(72) Inventors: Robert Leon Reynolds, Frisco, TX (US); Justin Michael Brown, Coppell, TX (US); Daniel James Thyer, Charlotte, NC (US)

(21) Appl. No.: 17/893,971

(22) Filed: Aug. 23, 2022

Related U.S. Application Data
(60) Provisional application No. 63/236,042, filed on Aug. 23, 2021.

(51) Int. Cl. G06N 5/04

(52) U.S. Cl. CPC G06N 5/04

(57) ABSTRACT

A semantic similarity fingerprint is generated for an image by inferring a plurality of SKUs each at an associated first weight based upon analysis of the image using the machine learning models. The associated first weights for each of the classifications based upon each machine learning model is the semantic similarity fingerprint. The semantic similarity fingerprint may be compared to previously generated semantic similarity fingerprints. If a match is found with a semantic similarity fingerprint that has previously been identified as a particular.

### BACKGROUND

The assignee of the present application has developed a validation system which images a stack of items, such as a stack of products on a pallet. The images are analyzed by the system using machine learning models to identify the skus of the items on the pallet. The identified skus are then compared to the skus on the picklist corresponding to the pallet. A user is notified of any errors, and the system may aid in correcting any such errors.

In one implementation, the skus are packages of beverage containers. Each sku has an associated package type and an associated brand. The possible package types include cartons of cans of a beverage, plastic beverage crates containing bottles or cans, cardboard boxes containing bottles, cardboard trays with a plastic overwrap containing plastic bottles. Additionally, there are different size bottles, different size cans, etc. The “brand” indicates the particular beverage contained therein (e.g. flavor, diet/regular, caffeine/no caffeine, etc). There are many different kinds of beverages that can be inside the many different beverage containers, although some beverages are only provided in a subset of the beverage containers. There are many different permutations of flavors, sizes, and types of beverage containers in each warehouse or distribution center.

Generally, the system must have some information about each sku in order to identify the skus in an image. For example, if the system is implemented using machine learning, the machine learning model must be trained with known sample images of each sku in order to be able to recognize that sku in an image of a stack of items on a pallet.

One of the challenges is being able to quickly incorporate new skus into the system quickly so that the new skus will be recognized by the system as they appear on pallets. Another challenge is that the appearance of the packaging of an existing sku will change (e.g. new branding, or promotional packaging, or seasonal packaging) before the machine learning model has been trained on the new packaging. Even for a given brand and a given package type, the exterior appearance of the package may vary. For example, often a beverage producer will change the exterior appearance of cartons of cans or the labels on bottles or the plastic wrap around bottles, such as for a holiday season, sponsored sporting event, or other promotion.

### SUMMARY

In order to vision verify a product on which the machine learning models have not yet been trained, a semantic similarity fingerprint is generated based upon an image of the product. The semantic similarity fingerprint is generated for each image by inferring a plurality of SKUs each at an associated first weight based upon analysis of the image using the machine learning models. The associated first weights for each of the classifications based upon each machine learning model is the semantic similarity fingerprint.

The semantic similarity fingerprint may be compared to previously generated semantic similarity fingerprints. If a match is found with a semantic similarity fingerprint that has previously been identified as a particular SKU, then the current image can be vision verified as being associated with that same SKU.

### BRIEF DESCRIPTION OF THE DRAWINGS

FIG. 1 shows one example of an imaging system.

FIG. 2 is a block diagram of a portion of the server of FIG. 1.

FIG. 3 is a block diagram of one of the paragon image groups of FIG. 2.

FIG. 4 is a block diagram of a semantic similarity fingerprint generated based upon a new image.

FIG. 5 is a flow chart of one method for operating the system of FIG. 1.

### DETAILED DESCRIPTION

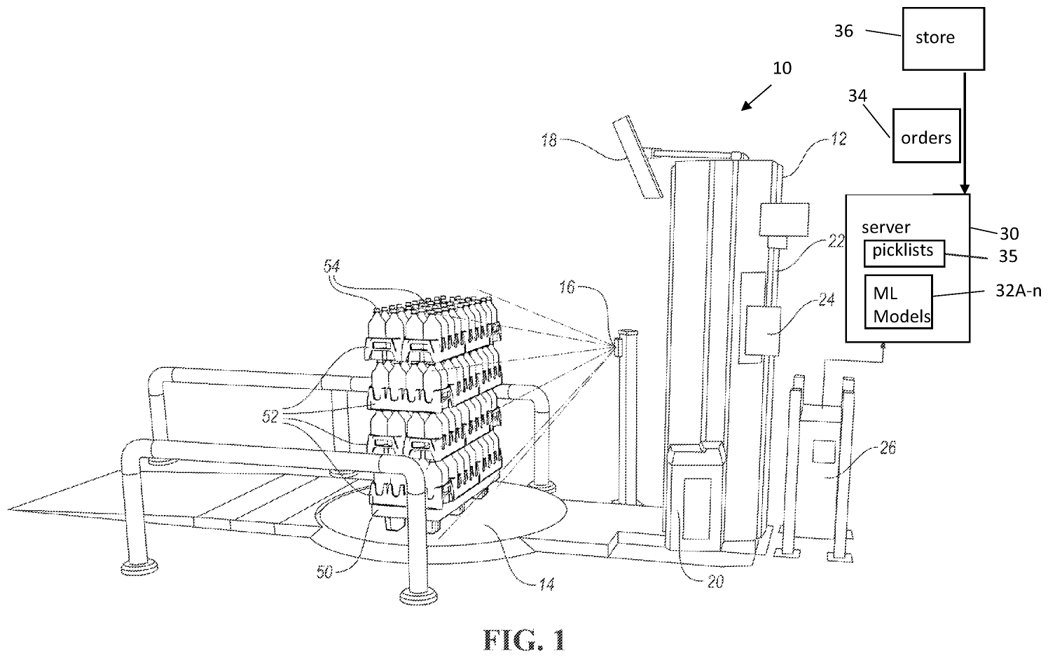

FIG. 1 shows one embodiment of an imaging system, which in this example is implemented as a pallet wrapper and imaging system 10. The system 10 includes a pallet wrapper 12 having a turntable 14 and at least one camera 16 directed toward the area above the turntable 14. A weight sensor (not visible) may be under the turntable 14 for measuring weight on the turntable 14. Alternatively, the imaging system 10 could be implemented independently of the wrapper.

Lights 18 may direct illumination toward the area above the turntable 14 to assist the camera 16. The computer 26 is programmed to control the turntable 14 and the camera 16 so that the turntable 14 rotates and the camera 16 takes one or more images of the loaded pallet 50. A roll of stretch film 20 is mounted to a tower 22 adjacent the turntable 14. As is known, the roll of stretch film 20 is mounted to be moved vertically on the tower 22, such as by a motor (not shown), while the turntable 14 rotates.

A user interface 24, such as a touchscreen, is mounted on or near the tower 22. A computer 26 includes at least one processor and storage which stores instructions which when executed by the processor perform the functions described herein. A server 30 includes a plurality of machine learning models 32 trained on images of the known skus in the warehouses, which in this example is packages 52 of beverage containers 54.

In use, the server 30 receives a plurality of orders 34 from stores 36 and presents a pick list 35 of skus to the worker, indicating which items 52 to place on each pallet 50. The worker places the items (e.g. the plastic bottle crates 52 with the plastic bottles 54) on the pallet 50 according to the pick list 35. The pallet 50, which could be a half-pallet or a full-size pallet, is loaded with items such as packages 52 of beverage containers 54, which may include secondary packaging such as plastic bottle crates 52 containing primary packaging, such as cans or bottles 54. The loaded pallet 50 is placed on the turntable 14 for validation and wrapping

Preferably, the computer 26 controls the camera 16, lights 18 and turntable 14 so that the camera 16 takes an image of each of the four sides of the loaded pallet 50. The assignee of the present application has developed a validation system that uses machine learning to identify skus of the items on the pallet 50. This is disclosed more fully in US20220129836, filed Oct. 22, 2021, assigned to the assignee of the present application and which is hereby incorporated by reference in its entirety.

Briefly, as described in previous patents, the computer 26 receives images from the camera 16 (and optionally weight data from the weight sensor), and communicates with the user interface 24. The computer 26 sends all collected data to the server 30, which could be a cloud computer that also receives the same data from other such systems 10 in the same warehouse and such systems 10 in other warehouses in other geographic locations around the world.

The computer 26 (or server 30) identifies the skus of the items 52 on the pallet 50 based upon the images of the stacked items 52 on the pallet 50. In one implementation, each image of the loaded pallet 50 is separated into images of each item 52 on the pallet 50. The packaging type of each item 52 on the pallet 50 (which in this example is a known/expected combination of both the secondary packaging and the primary packaging) is first identified using one machine learning model 32 to analyze the images of the items 52 on the loaded pallet 50. The package types may include, just as illustrative examples, plastic beverage crate with eight 2-liter plastic bottles (shown in FIG. 1), plastic beverage crate with twenty-four 20 oz plastic bottles, corrugated cardboard box, cardboard tray with twenty-four 20 oz plastic bottles and plastic overwrap, cardboard box holding thirty-six 12 oz aluminum cans, and others.

The “brand” (i.e. the specific content, such as the flavor and type of the beverage) is then identified using another machine learning model 32 (which may have has been selected from among a plurality of brand machine learning models 32 based upon the identified package type) to analyze the images of the items on the pallet 50. The computer 26 then compares the identified skus to the expected skus on the pick list 35 and generates alerts (such as on user interface 24) for any mismatches.

This application provides an improved system 10 and method for validating new skus and for validating skus with new packaging. This could be used to reduce the frequency of updating the machine learning models 32 and to improve the accuracy of the validation system 10 before the machine learning models 32 are updated.

Semantic Similarity

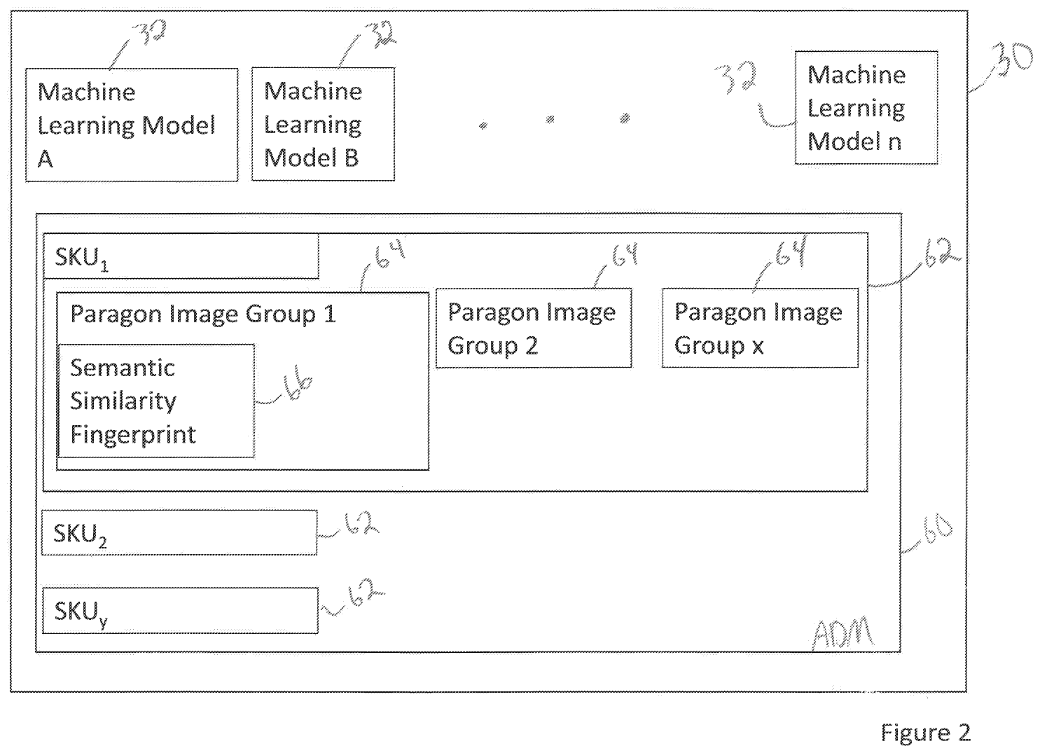

Referring to FIG. 2, the system 10 may encounter a product that has not yet been trained in the machine learning models 32 on the server 30. The following technique can be used to verify new SKUs before the models 32 are trained on them.

The server 30 stores the machine learning models 32 and an Average Distance Meta-File—ADM 60. The ADM 60 has a SKU record 62 for each SKU. Each SKU record 62 includes at least one, and more likely a plurality of paragon image groups 64. Each paragon image group 64 is a set of images of a SKU that all look similar to each other. Normally each SKU record 62 will have many paragon image groups 64. For example, each SKU orientation view (side view, end view, top view, bottom view) may have its own paragon image group 64. Additional paragon image groups 64 will be created for the SKU record 62 for changes in branding or packaging. Each paragon image group 64 for a SKU record 62 will have its own semantic similarity fingerprint 66.

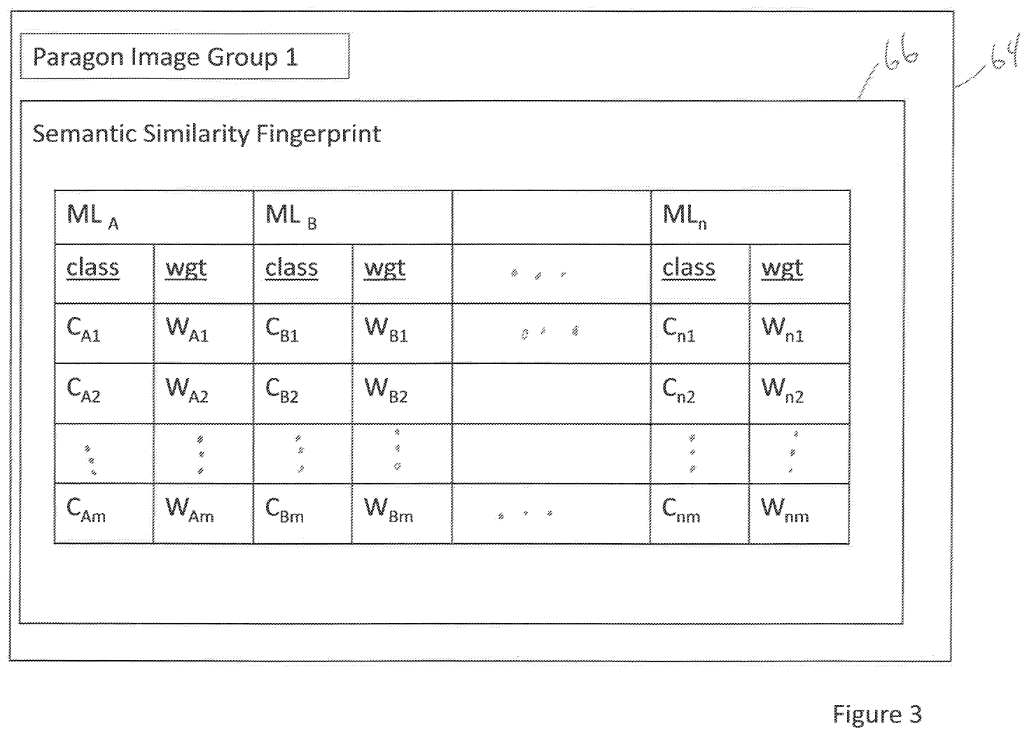

FIG. 3 a block diagram of one of the paragon image groups 64. The semantic similarity fingerprint 66 is the data that is used to judge if one image is similar to another image. As shown, an array of the top tuples (classification (brand) and weight (% confidence)) for each classification machine learning model 32 is used. If n classification machine learning models 32 are used, then there will be n different arrays (one for each model). The array of tuples (class and weight) of the top m number of classes for each model that have the highest weights for each model will be used. For example, in FIG. 3, the semantic similarity fingerprint 66 for this paragon image group 64 has classes C_{A1} to C_{Am} for machine learning model 32 (ML_{A}) with corresponding weights W_{A1} to W_{Am}. The weights may be the confidence levels corresponding to the associated classification resulting from that machine learning model 32 (ML_{A-n}). The semantic similarity fingerprint 66 can be made from a single image or the weights from the top classes for each model can be averaged together to form the average weight per class for the fingerprint.

Semantic similarity concepts from Siamese Networks are used to know if two SKUs are likely the same. This is used for identifying new SKUs not yet trained in the machine learning models 32 from paragon image groups 64 of the SKU record 62. This is also used for identifying updated SKUs with changes in branding or packaging. Changes in packaging may be temporary, like if the bottle runs out of cardboard trays, the bottler may use overwrap for a week or so.

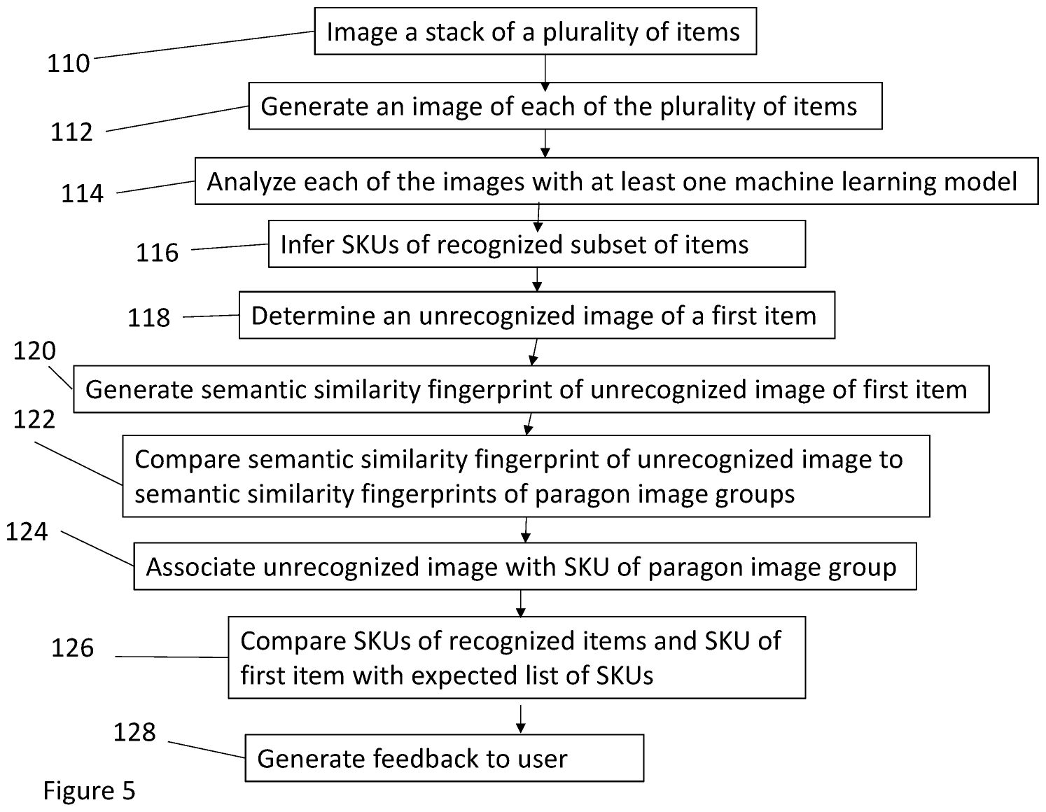

Referring to FIG. 1 and the flowchart of FIG. 5, the camera 16 takes a plurality of images of the stack of items 52 on the pallet 50 in step 110. The images are received by the computer 26. In step 112, the computer 26 and/or the server 30 separates the portions of each image that correspond to each item 52. Each image would be one face of the one of the packages 52 on the pallet 50.

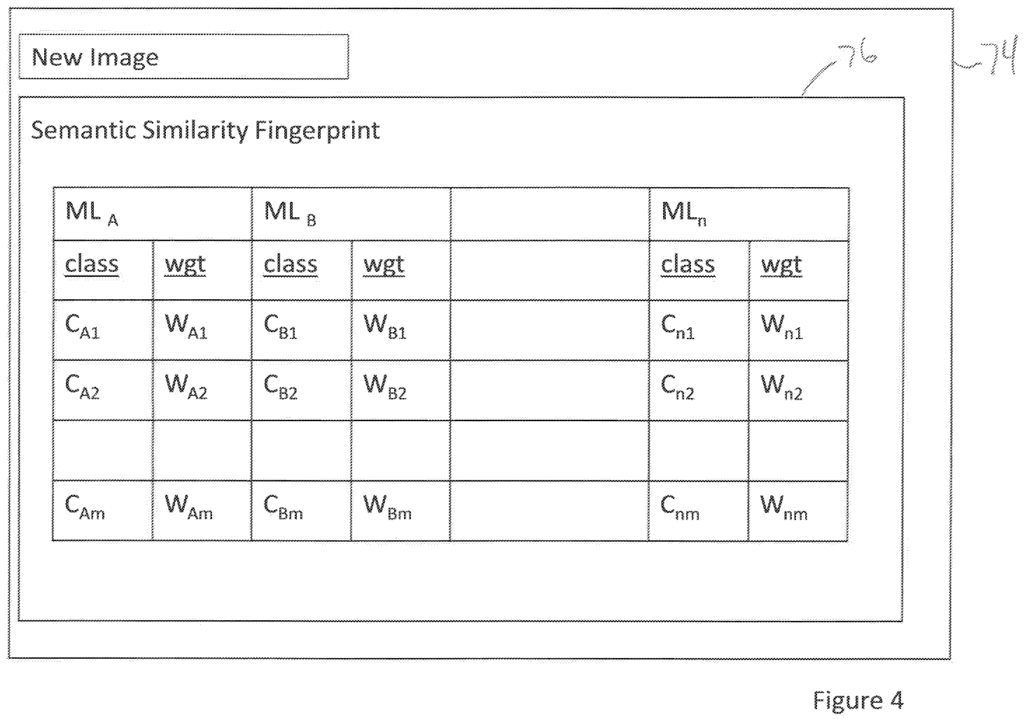

Referring to FIGS. 4 and 5, the images of the items including a new image 74 of a SKU (such as package 52) is received and analyzed by the server 30 using the machine learning models 32A-n in step 113. In step 116, the server 30 infers the SKUs of items for which the machine learning models 32A-n have been trained as in the previous method (i.e. the confidence level is above a threshold). Also, as before, in step 118, the server 30 determines an unrecognized image of a first item for which the machine learning models 32A-n have not been trained (i.e. the confidence level is below a threshold).

In step 120, the server 30 generates the semantic similarity fingerprint 76 of the new image of the first item. The semantic similarity fingerprint 76 of the new image 74 of the SKU is utilized to vision verify the SKU before a new or changed SKU is trained. This is valuable because the system 10 can vision verify SKUs and train the models 32 much less frequently.

All the brand models 32A-n that are used for classification are used to create the semantic similarity fingerprint 76 to characterize the image 74. Semantic similarity is what is important, so it is not required that the brand be a class that was trained in the model 32. The semantic similarity fingerprint 76 is used and not just the model 32A-n in which that brand was trained.

In step 122, it is determined whether the semantic similarity fingerprint 76 of the new image 74 is similar to a semantic similarity fingerprint 66 of a SKU record 62 in the ADM 60 by calculating the distance from the weights from the same classes in the array of tuples for each model. The smaller the distance the more likely that the two images are the same SKU.

For example, if there are 800 classes (brands), each with a confidence weighting, then each fingerprint can be defined in 800-coordinate space. However, in practice, confidence weightings below a given threshold (e.g. 1% or 0.1%) can be ignored.

The semantic similarity fingerprint 76 of the new image 74 is compared to the semantic similarity fingerprints 66 of all the paragon image groups 64. If the semantic similarity fingerprint 76 of the new image 74 is determined to be within a threshold distance from a semantic similarity fingerprint 66 of one of the paragon image groups 64, then the new image 74 can be vision verified to be that SKU corresponding to that semantic similarity fingerprint 66 in step 124. The package 52 corresponding to the new image 74 can be identified as that SKU. In step 126, that identified SKU is then compared (along with the rest of the identified SKUs, which may have been identified by the server 30 as SKUs on which the machine learning models 32 were trained, or according to the semantic similarly method or a mixture of both) to the expected SKUs (i.e. from a picklist 35 and from an order 34). In step 128, the user is alerted to any mismatches between the SKUs identified on the pallet 50 and the expected SKUs from the picklist 35 (as before).

Referring again to FIG. 2, paragon image groups 64 expire and new ones are created when needed. When the distance changes by more than a threshold from any of the present images, the server 30 adds a paragon image group 64. When a semantic similarity fingerprint 66 is far from any existing semantic similarity fingerprint 66, a new paragon image group 64 may be created. This may be for a new SKU record 62 or for an existing SKU 62 with new packaging.

Information about a SKU record 62 and a pallet 50 is leveraged to judge if it is a candidate for a paragon image group of the SKU record 62. The pick list 35 indicates what is supposed to be on the pallet 50. If all but one of the packages 52 on the pallet 50 can be vision verified, then the one that is not vision verified is likely a candidate for a paragon image group 64. If there are many image samples with semantic similarity fingerprints 76 within a threshold distance from one another, then the group of images can be saved and created as a paragon image group 64. Weight may also used to know that there is high confidence that the correct SKU is on the pallet 50. If there are many image samples of the SKU with a low distance from the weighted class profile array, then a new paragon image group 64 can be saved.

When the server 30 sees another product 52 with the same semantic similarity fingerprint 76 (within a certain distance threshold), the server 30 recognizes the product 52 as the previously-identified SKU. Again, this product 52 would be matched to its associated SKU on the pick list 35 as well. The semantic similarity fingerprints 76 of the two products 52 (along with any other subsequent products 52 with matching semantic similarity fingerprints 76) could be averaged together (i.e. the coordinates are averaged) to form the semantic similarity fingerprint 66 of the paragon image group 64. This provides vision verification of the new SKUs or SKUs with new packaging until the machine learning models 32 are updated. The images within a threshold distance of the average can later be used for training the machine learning models 32 when they are eventually updated.

It should be understood that each of the computers, servers or mobile devices described herein includes at least one processor and at least one non-transitory computer-readable media storing instructions that, when executed by the at least one processor, cause the computer, server, or mobile device to perform the operations described herein. The precise location where any of the operations described herein takes place is not important and some of the operations may be distributed across several different physical or virtual servers at the same or different locations.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers for steps or operations are solely for ease in reference in dependent claims and such identifiers by themselves do not signify a required sequence of performance, unless otherwise explicitly specified.

What is claimed is:

1. A computing system for validating a stack of a plurality of packages comprising:
at least one processor; and
at least one non-transitory computer-readable medium storing:
at least one machine learning model that has been trained with a plurality of images of packages of beverage containers; and
instructions that, when executed by the at least one processor, cause the computing system to perform operations comprising:
a) receiving an image of one of the plurality of packages of beverage containers;
b) inferring a plurality of SKUs each at an associated first weight based upon the image using the at least one machine learning model;
c) comparing the inferred SKUs and weights to a semantic similarity fingerprint of a known SKU, wherein the semantic similarity fingerprint of the known SKU associates each of the plurality of SKUs with a second weight;
d) based upon operation c), determining whether the one of the plurality of packages corresponds to the known SKU.

2. The computing system of claim 1 wherein the at least one machine learning model is not trained on images of the known SKU.

3. The computing system of claim 1 wherein the at least one machine learning model is not trained on images of a SKU associated with the one of the plurality of packages.

4. The computing system of claim 1 wherein the at least one machine learning model includes a plurality of machine learning models.

5. The computing system of claim 4 wherein operation b) is performed for each of the plurality of machine learning models.

6. The computing system of claim 5 wherein the semantic similarity fingerprint of the known SKU associates each of the plurality of SKUs with the second weights in each of the plurality of machine learning models.

7. The computing system of claim 1 wherein the semantic similarity fingerprint of the known SKU is a second semantic similarity fingerprint, and wherein a first semantic similarity fingerprint is generated by operation b).

8. The computing system of claim 7 wherein the at least one non-transitory computer-readable medium stores a plurality of SKU records each having a plurality of semantic similarity fingerprints associated therewith, including the second semantic similarity fingerprint.

9. A computing system for validating packages comprising:
at least one processor; and
at least one non-transitory computer-readable medium storing:
at least one machine learning model that has been trained with a plurality of images of packages labeled with a plurality of first SKUs; and
instructions that, when executed by the at least one processor, cause the computing system to perform operations comprising:
a) receiving a first image of a first package;
b) based upon the first image, generating a first semantic similarity fingerprint by inferring the plurality of first SKUs each at an associated first weight using the at least one machine learning model;
c) receiving a second image of a second package;
d) based upon the second image, generating a second semantic similarity fingerprint by inferring the plurality of first SKUs each at an associated second weight using the at least one machine learning model;
e) comparing the first semantic similarity fingerprint to the second semantic similarity fingerprint;
f) based upon operation e), determining whether the first package and the second package are associated with a same SKU.

10. The computing system of claim 9 wherein the at least one machine learning model is not trained on images of the same SKU.

11. The computing system of claim 9 wherein the at least one machine learning model includes a plurality of machine learning models.

12. The computing system of claim 11 wherein in operation b), the first semantic similarity fingerprint is generated by inferring each of the plurality of first SKUs using each of the plurality of machine learning models.

13. The computing system of claim 12 wherein in operation d), the second semantic similarity fingerprint is generated by inferring each of the plurality of first SKUs using each of the plurality of machine learning models.

14. The computing system of claim 13 wherein the operations further include storing an SKU record having the first semantic similarity fingerprint and associating the first semantic similarity fingerprint with a new SKU.

15. A method for validating a plurality of packages using a computer including:
a) receiving an image of one of the plurality of packages;
b) inferring a plurality of SKUs each at an associated first weight based upon the image using at least one machine learning model that has been trained with a plurality of images of packages;
c) comparing the inferred SKUs and weights to a semantic similarity fingerprint of a known SKU, wherein the semantic similarity fingerprint of the known SKU associates each of the plurality of SKUs with a second weight;
d) based upon operation c), determining whether the one of the plurality of packages corresponds to the known SKU.

16. The method of claim 15 wherein the at least one machine learning model is not trained on images of the known SKU.

17. The method of claim 15 wherein the at least one machine learning model is not trained on images of a SKU associated with the one of the plurality of packages.

18. The method of claim 15 wherein the at least one machine learning model includes a plurality of machine learning models and wherein step b) further includes inferring a plurality of SKUs each at the associated first weight based upon the image using each of the plurality of machine learning models.

19. The method of claim 18 wherein the semantic similarity fingerprint of the known SKU associates each of the plurality of SKUs with the second weights in each of the plurality of machine learning models.

20. A method for validating packages using a computer including:
a) receiving a first image of a first package;
b) based upon the first image, generating a first semantic similarity fingerprint by inferring the plurality of first SKUs each at an associated first weight using at least one machine learning model that has been trained with a plurality of images of packages labeled with a plurality of first SKUs;
c) receiving a second image of a second package;
d) based upon the second image, generating a second semantic similarity fingerprint by inferring the plurality of first SKUs each at an associated second weight using the at least one machine learning model;
e) comparing the first semantic similarity fingerprint to the second semantic similarity fingerprint;
f) based upon step e), determining whether the first package and the second package are associated with a same SKU.

21. The method of claim 20 wherein the at least one machine learning model is not trained on images of the same SKU.

22. The method of claim 20 wherein the at least one machine learning model includes a plurality of machine learning models.

23. The method of claim 22 wherein step b) includes inferring each of the plurality of first SKUs using each of the plurality of machine learning models.

24. The method of claim 23 wherein step d) includes inferring each of the plurality of first SKUs using each of the plurality of machine learning models.

25. The method of claim 24 further including storing a SKU record having the first semantic similarity fingerprint and associating the first semantic similarity fingerprint with a new SKU.
